(19) United States
(12) Patent Application Publication
(10) Pub. No.: US 2009/0095369 A1
(43) Pub. Date: Apr. 16, 2009

(54) Apparatus and method of filling a flexible pouch with extended shelf life

(76) Inventor: R. Charles Murray, Lakewood, FL (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/454,241

(22) Filed: Jun. 16, 2006

Related U.S. Application Data
(60) Provisional application No. 60/691,401, filed on Jun. 16, 2005.
(60) Provisional application No. 60/691,088, filed on Jun. 16, 2005.

(51) Int. Cl. B67C 3/10; B67C 3/24; B65D 30/10; A23L 3/02

(52) U.S. Cl. 141/5; 383/107; 383/80; 383/104; 383/109; 426/521; 141/82; 141/250

(57) ABSTRACT

A compact apparatus and method for filling a flexible pouch having an extended shelf life is provided. The machine includes a frame, a transport means disposed on the frame for transporting a pouch holder containing the flexible pouch. The machine also includes a receiving station for placing the pouch into the pouch holder, and an opening station for opening the pouch to separate the walls of the pouch, a filling station for filling the pouch and a closing station for closing the filled pouch. The machine further includes a pasteurization station. The flexible pouch includes a panel having an upper edge, an opposed lower edge and a first side edge and a second side edge extending therebetween the upper edge and the lower edge, the upper edges are sealed along an upper seam and a fitment opening means is disposed in the upper seam for accessing the product.

### RELATED APPLICATIONS

This application claims priority of United States Provisional Patent Applications Ser. Nos. 60/691,401 and 60/691,088 filed Jun. 16, 2005, which are incorporated herein by reference.

### BACKGROUND OF THE INVENTION

1. Field of the Invention

The present invention relates generally to a flexible pouch for packaging a product and, more specifically, to an apparatus and method of forming and filling a flexible pouch for packaging a product to have an extended shelf stable life.

2. Description of the Related Art

Various types of disposable, portable containers are known in the art for storing a fluid or dry product, such as a liquid, granular material, powder or the like. An example of such a container is a flexible pouch. Consumers prefer the convenience of flexible pouches over other types of containers, due to their shape, size, shelf life and storage adaptability. Manufacturers recognize the packaging benefits of a flexible pouch, since the pouch can be formed and filled on the same manufacturing line. An example of a method and apparatus for filling a flexible pouch with a product is disclosed in commonly assigned U.S. Pat. No. 6,199,601, which is incorporated herein by reference.

The flexible pouch is preferably made from a flexible material, such as an extrusion or laminate composed of sheets of plastic or aluminum or the like. An outer layer of the material may include preprinted information, such as a logo or the like, to provide the consumer with information regarding the contents of the pouch.

The pouch may be formed on an automated machine using conventionally known manufacturing techniques. Typical machines include a horizontal multiple lane, high speed machine, a flat bed machine, or the like. The machine includes a number of stations, with a particular operation taking place at each station. For example, at one station the pouch is generally formed by folding a sheet or sheets of material over each other to achieve a predetermined shape. The pouch may also include an insert or gusset positioned between two parallel edges, to form a pouch capable of standing unsupported. Edges, such as a side edge, may be joined together at a sealing station using a sealing technique such as bonding or welding. Alternatively, the roll is folded to form a pouch with three open sides. The pouch may include an opening means that is inserted at another station. One example of an opening means is a fitment. With some pouches, an upper or lower edge of the front panel and the back panel is generally not sealed until after the pouch is filled. The complete, empty pouch may be placed in a holder, such as a cup or puck, to transport it between stations. Alternatively, a pouch with a fitment may be transported by supporting the fitment using a ring. To fill the pouch, the upper edges of the pouch are spread apart at an opening station. For example, grippers or suction cups or a combination of both may be utilized to pull the panels apart. In addition, a concentrated flow of gas may be directed towards the upper edge of the pouch to further separate the panels. The open pouch is filled at a filling station, sealed at a sealing station and finished as necessary.

These types of automated, high-speed machines work very well for manufacturing a pouch for packaging most types of products. However, with certain fresh food products, it is desirable for the pouch to have extended shelf stable life, such as through refrigeration or pasteurization. In addition, while compact filling machines are known, they have not previously accommodated a flexible pouch, an ultrasonic closing seal, or an ultrasonic and heat seal combined, such as that utilized for a carbonated product. Thus, there is a need in the art for an apparatus and method of filling a flexible pouch with a carbonated product so that the filled pouch has an extended product shelf life.

### SUMMARY OF THE INVENTION

Accordingly, the present invention is an improved compact apparatus and method for filling a flexible pouch, and an improved flexible pouch for storing and serving a product that has an ergonomic shape for holding the pouch while consuming the product. The ergonomic flexible pouch includes a panel having an inner surface and an outer surface, and an upper edge, an opposed lower edge and a first side edge and a second side edge extending therebetween the upper edge and the lower edge. The panel is folded lengthwise so that the side edges form one sealed side seam and the folded edge forms a soft side edge that is ergonomically shaped for holding the pouch while consuming the carbonated product. The upper edges are sealed along an upper seam and the lower edges are sealed along a lower seam. For a carbonated product, the seal includes a first ultrasonic seal and a second seal spaced a predetermined distance from the first seal so that some of the product is trapped between the first and second seal. An opening means is disposed in the upper seam for accessing the product contained within the pouch. The flexible pouch is pasteurized for extended shelf lie of the product.

The method of filling a flexible pouch with a product using a compact machine for extended shelf life of the filled pouch includes the steps of placing a premade flexible pouch in holder for transporting the pouch between stations on a compact machine. The method also includes the step of opening the pouch at an opening station on the compact machine by directing a flow of gas between either the open lower edges of the pouch to separate the walls of the pouch, or through the spout fitment. The method further includes the step of filling the pouch at a filling station on the compact machine with the product using a filling nozzle. The method still further includes the step of sealing the open edge of the pouch at a sealing station by applying a first ultrasonic seal and a second seal spaced a predetermined distance from the first seal so that some of the product is trapped between the first and second if filled through an open edge or placing a cap on the fitment if filled through the fitment. The method includes the steps of removing the filled pouch from the compact machine. The method further includes the step of pasteurizing the pouch for extended shelf life.

The compact apparatus for filling the flexible pouch includes a frame having a planar top and legs supporting the top, and a transport means disposed on the frame top for transporting a pouch holder that supports the flexible pouch. The compact apparatus also includes a receiving station for placing an unfilled flexible pouch into the pouch holder, and an opening station mounted to the frame for opening the pouch by directing a flow of gas between either the open lower edges of the pouch or through the cap, to separate the walls of the pouch. The apparatus further includes a filling station mounted to the frame for filling the opened pouch with a product using a filling means. The apparatus still further includes a closing station mounted to the frame for either sealing the open edge of the pouch by applying a first ultrasonic seal and a second seal spaced a predetermined distance from the first seal so that some of the product is trapped between the first and second seal, or capping the spout fitment. The apparatus yet further includes a pasteurization station for pasteurizing the product contained within the pouch.

One advantage of the present invention is that a method of filling and sealing a flexible pouch using an improved compact apparatus that forms an ultrasonic seal is provided. Another advantage of the present invention is that the improved compact filling apparatus can be used in conjunction with a retort chamber to pasteurize the filled pouch so that a shelf stable pouched product is provided. Still another advantage of the present invention is that a compact filling apparatus is provided that includes an ultrasonic seal operation, with or without a second heat seal. Still a further advantage of the present invention is that the method and compact filling apparatus for filling the flexible pouch improves the cost-effectiveness of filling a pouch with a product having an extended shelf life on-site. Still yet a further advantage of the present invention is that the method and compact filling apparatus for filling the flexible pouch avoids excessive film creepage, expansion or flavor contamination. Still another advantage of the present invention is that the filled flexible pouch may be refrigerated or pasteurized to maintain quality and extend shelf stable life. A further advantage of the present invention is that the flexible pouch may have an ergonomic shape to facilitate holding of the pouch while being consumed.

Other features and advantages of the present invention will be readily appreciated, as the same becomes better understood after reading the subsequent description taken in conjunction with the accompanying drawings.

### BRIEF DESCRIPTION OF THE DRAWINGS

FIG. 1 is an elevational view of an ergonomically shaped flexible pouch, according to the present invention.

FIG. 2 is an elevational view of another flexible pouch, according to the present invention.

FIG. 3 is yet another elevational view of a flexible pouch, according to the present invention.

FIG. 4a is a flowchart of a method of forming a flexible pouch, according to the present invention.

FIG. 4b is a flowchart of a method of filling and sealing a flexible pouch, according to the present invention.

FIG. 5 is an elevational view of a flexible pouch prior to filling, according to the present invention.

FIGS. 6a-6d are various views of a compact apparatus for filling and sealing a flexible pouch using the method of FIG. 5.

FIG. 7 is a diagram illustrating the stations for the compact apparatus of FIG. 6, according to the present invention.

### DESCRIPTION OF THE PREFERRED EMBODIMENT(S)

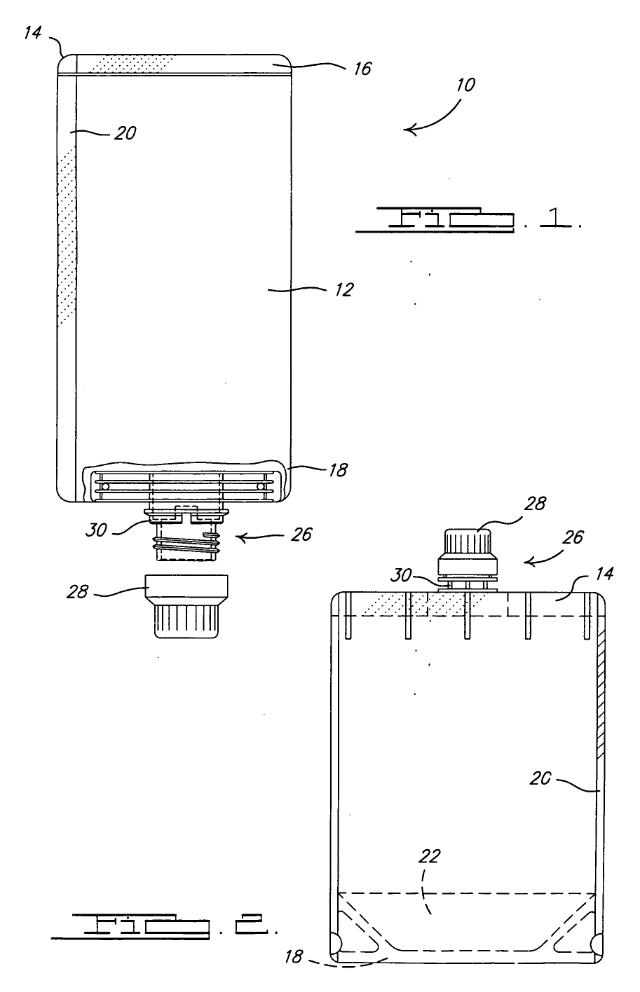

Referring to FIGS. 1-3, a sealed, flexible pouch 10 is illustrated. The pouch 10 is filled with a product (not shown) and sealed. The filled pouch may assume various shapes, such as cylindrical, cube, conical or the like. The type of product and usage of the pouch influences the shape. The type of product is unlimited, and could have a solid or a liquid form. The product is preferably a food item and the pouch may contain a single serving, or multiple servings of the food product. In this example, the pouch 10 is a flexible stand-up pouch suitable for a product with extended shelf life, including extended refrigerated shelf life. Various types of products are contemplated, such as a dry food product or a fluid or the like. In this example, the product is pasteurized. Examples of pasteurized food products include beer or wine or the like. Another example of a pasteurized food product includes dairy products such as milk, or meat products such as chicken or the like.

The flexible pouch 10 is preferably formed from a roll of flexible, preprinted laminate material. The choice of laminate material is nonlimiting, and is influenced by factors such as the product contained in the pouch 10, the shape of the pouch or the anticipated use of the pouch. Preferably, the laminate is either a three, four or five gauge material, and the outer layer is preprinted. It should be appreciated that a portion of the material may be a clear laminate, in order to view the contents of the pouch. For example, the laminate material may include at least one layer of virgin polyethylene terphalate (PET) and at least one layer of aluminum foil (AL) and another layer such as EVOH, PET, polyethylene, or polypropylene or nylon or the like. The laminate may also include a metalized foil paper layer laminated to a cast polypropylene layer and another layer of PET, polyethylene or EVOH. It should be appreciated that there may be a fourth layer of nylon. Another material example includes a cast polypropylene (CPP) layer, a polyethylene (PET) layer, a foil (AL) layer, a nylon (ONO) layer and another CPP layer. Another example of a material structure is the use of nylon, foil, nylon, and cast polypropylene (ONO/AUONO/CPP) or CPP/NY/AL/CPP. A further example of a laminate material structure is CPP/AL/ONO/PE. This structure works well when the product has a short shelf life, and the nylon eliminates stretching or cracking of the AL layer. Advantageously, a pouch 10 made using the cast polypropylene laminate material retains its filled shape even as the product is removed from the pouch 10.

It should be appreciated that if the filled carbonated pouch is stored at ambient temperature, the laminate will start to creep after a period of time, such as ten days. The laminate material may include an extrusion layer to contain “creepage” or “stretch” of the film after filling due to carbonation expansion, if the product is carbonated. In addition, the selected material may be organoleptic compliant in order to avoid the transfer of odor contaminants to the product, or product contamination during the shelf life period of the product.

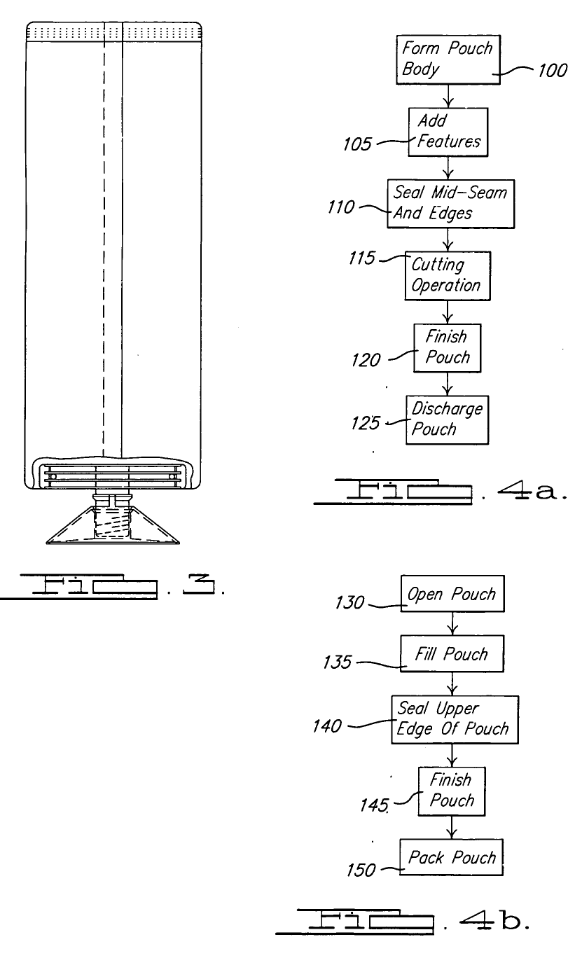

The pouch 10 itself is defined by a panel, which may be formed using one or more sheets of material. In this example, the pouch 10 includes a front wall 12 and a back wall 14, and the edges are joined along a seam. With one sheet of material, it is folded so that the outer edges are joined together to form one seam, such as the side seam of FIG. 1. Alternatively, the pouch may be formed from two facing panels of material that are joined together along corresponding side edges, as shown in FIG. 2.

Further, the pouch is defined by an upper edge 16, an opposed lower edge 18, and at least one side edge 20 extending therebetween the upper and lower edges 16, 18. The edges of the pouch 10 are sealed using heat or ultrasonically or by a combination of heat and ultrasonically. As shown in the example of an ergonomically shaped pouch illustrated in FIG. 1, the pouch includes three fin-style seams, such as an upper seam, a bottom seam and a side seam. This style of pouch 10 advantageously facilitates handling of the pouch by the consumer. One of the bottom seams may include a fitment sealed between the walls of the pouch, such as a spout. The pouch 10 has a generally cylindrical shape, although other shapes are contemplated.

The pouch 10 may include a sidewall as shown in FIG. 2. The sidewall advantageously allows the pouch 10 to acquire another shape, such as cylindrical, or to stand upright. The sidewall may be integrally formed in the panel as a gusset 22 or a separate piece of material as an insert (not shown). The sidewall may be located between the side edges of the panels, between the lower edges, between the upper edges, or a combination thereof. The gusset 22 or insert may be generally wider at the lower edge and taper upwardly towards the upper edge, or be of a uniform dimension. The sidewall may be formed between the lower edges of the pouch 10 to provide a base for the pouch 10 to stand upright, as shown in FIG. 2. A sidewall formed between the side or upper edges may serve as an area for receiving an opening means 26, to be described.

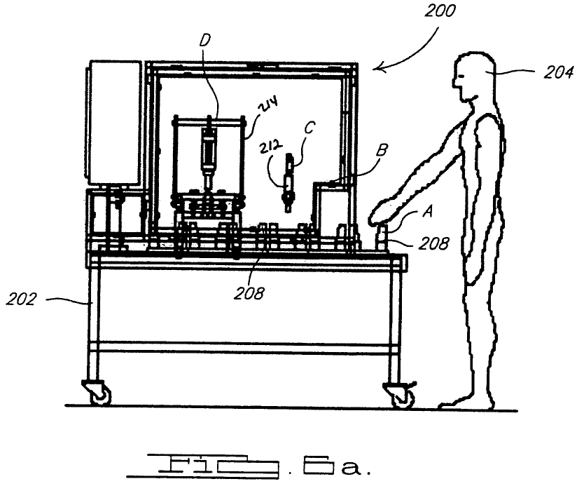

The pouch 10 further includes an opening means 26 for accessing the contents of the pouch. Various types of opening means 26 are known in the art for this purpose. An example of an opening means 26 for accessing the contents or dispensing the contents from the pouch 10 is a cap 28 secured to a fitment 30. The fitment is made from a material such as polypropylene. It should be appreciated that the fitment 30 is usually applied prior to filling the pouch. The fitment is sealed, such as ultrasonically or heat sealed, between the edges of the pouch. The pouch 10 may be filled through the open opposite end as shown in FIG. 5 or through the spout 30 as shown in FIG. 1. The cap 28 in this example can withstand carbonation, leads up to 5 g of carbon dioxide (5 volumes) and is applied to the fitment thread after the pouch has been filled through the fitment. The spout fitment may have a tamper-evident means. In this example, the spout fitment has an opening ranging from 8 mm to 35 mm in diameter, depending on the intended use. If the product is a carbonated product, the spout fitment may include a carbonation insert and oxygen scavenger to help prevent cap distortion.

Another example of an opening means 26 is a straw-pierceable portion for receiving a straw. Still another example of an opening means is a resealable fitment, such as a zipper that is sold under the name TopTite™. A further example of an opening means 26 is a tear-off portion. The tear-off portion usually has an integral tear notch 34 for initiating the tearing. Still a further example of an opening means is a pull tab covering an opening in the pouch.

It should be appreciated that the pouch 10 may include other components or features, as is known in the art. For example, the unfilled flexible pouch 10 may advantageously include a guide pocket 24 formed in a panel or wall of the pouch 10 prior to filling and sealing, to facilitate the separation of the front and rear panels prior to the filling of the pouch 10, as shown in FIG. 5. An example of a pouch with a guide pocket 24 is disclosed in commonly assigned U.S. patent application Ser. No. 10/310,221. Still another example of a component or feature is an integrally formed label, which may include a barcode. The barcode enables information, such as shipping data, of shelf life or the like, to be read by a scanner.

The pouch 10 may form one compartment for the product, as shown in FIGS. 1 and 2. Alternatively, the pouch 10 may include multiple discrete compartments. An example of such a pouch is disclosed in commonly assigned U.S. patent application Ser. No. 11/367,613, which is incorporated herein by reference.

It is contemplated that the pouch may undergo a secondary process after it is filled with the product. For example, the filled pouch may be pasteurized in order to have an extended shelf stable life under ambient temperature, in a manner to be described. Further, the pouch may incorporate any of the above-described features in any combination. The finished pouch may assume various shapes, such as cylindrical, cubical, conical or the like, as influenced by the type of product and intended usage of the pouch.

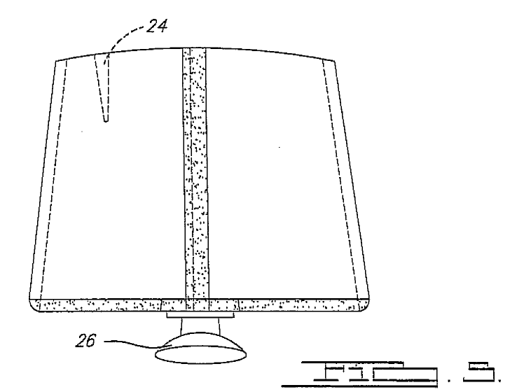

Referring to FIG. 4a, a method for forming the flexible pouch 10 using a high-speed machine is illustrated. It should be appreciated that the pouch may be a single-use pouch or a large multiple-use pouch. The pouch may also be a stand-up pouch, as previously described.

The method begins in block 100 at a first station with the step of forming the body of the pouch. For example, a roll of material is unrolled along a horizontally oriented plane. The initial width of the roll of material is determined by the desired finished size of the pouch and the number of pouches obtained from the width. Typically, three to four pouches, representing six to eight panels, can be obtained from a width of the roll of material on a three-lane machine or four-lane machine, respectively. An example of a flat bed pouch forming machine is manufactured by NISHIBE or a form-fill seal machine by Laudenberg. The film may pass through an ultraviolet light chamber without reflection to remove pathogen and microbiological contaminants.

The roll width of the aligned unrolling material is split into sections at a cutting station. For the example of a one-panel pouch, the material is cut into one section. For the example of a two-panel pouch, the material is split into two sections at the cutting station. Each section has a front side and a back side.

The methodology advances to block 105 and a feature such as a gusset or insert is optionally applied between the aligned first and second unrolling sections of material. A fitment, such as a spout, may be inserted at this station, or alternatively at a later station.

The methodology advances to block 110 and an edge is sealed. For example, a heat seal is applied to the combined first and second unrolling sections of material to form the seam joining the front panel to the back panel in a heat-sealing operation. The lower edge of each pouch may also be sealed at this time. One example of a sealing process is a heat weld that includes the application of heat and compression. Another example of a seal is an ultrasonic seal. Still another example of a seal is a combination of a heat seal and an ultrasonic seal.

The methodology advances to block 115, and the pouch is separated from the roll in a cutting operation. In the example of a multiple lane machine, each pouch formed in the roll width of material is separated from each other into individual pouches in a cutting operation. Each section of material may be first separated into panels along its width, or the side seam of the pouches. In this example, the width represents the side seams. The material is cut using a known cutting apparatus, such as a laser or punch or the like. The cut may be performed using a cutter or a die cut or the like. The pouches may be separated using a double step cutting process whereby two cuts are made at the same time, to separate two pouches at the same time from the roll of material.

The methodology advances to block 120 and the separated pouches are further finished. For example, a lower edge of the pouch may be trimmed to shape, i.e. the corners may be angled. Alternatively, the methodology may include the step of applying a fitment. The sequencing of this step is determinable by the type of fitment.

The methodology may include the step of forming a crease or guide pocket in a top portion of each panel 12, 14 in a creasing operation, in order to facilitate opening and filling of the pouch. An example of a method of forming a crease in a panel to facilitate opening the pouch is disclosed in commonly assigned patent application Ser. No. 10/310,221, which is incorporated herein by reference.

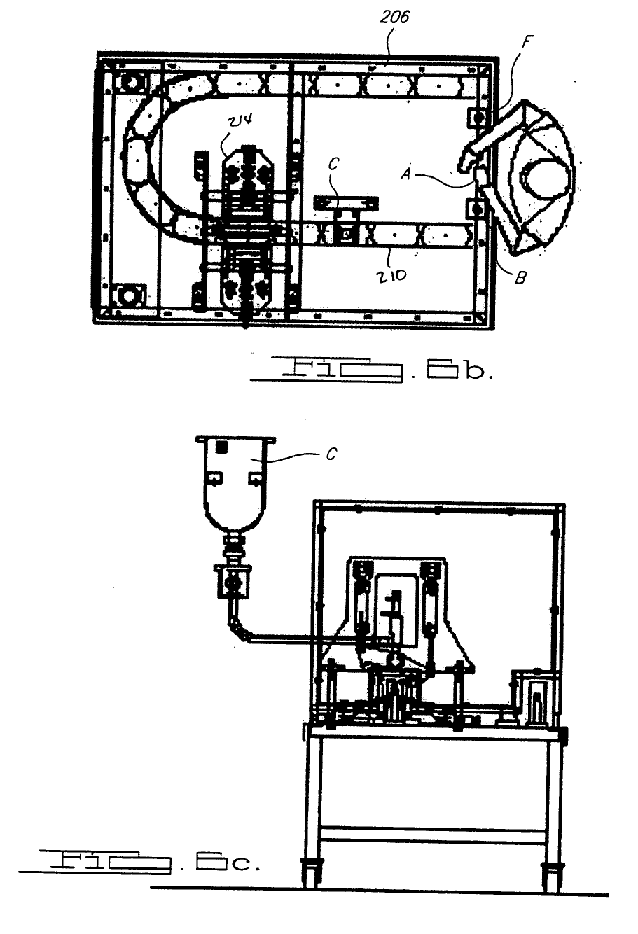

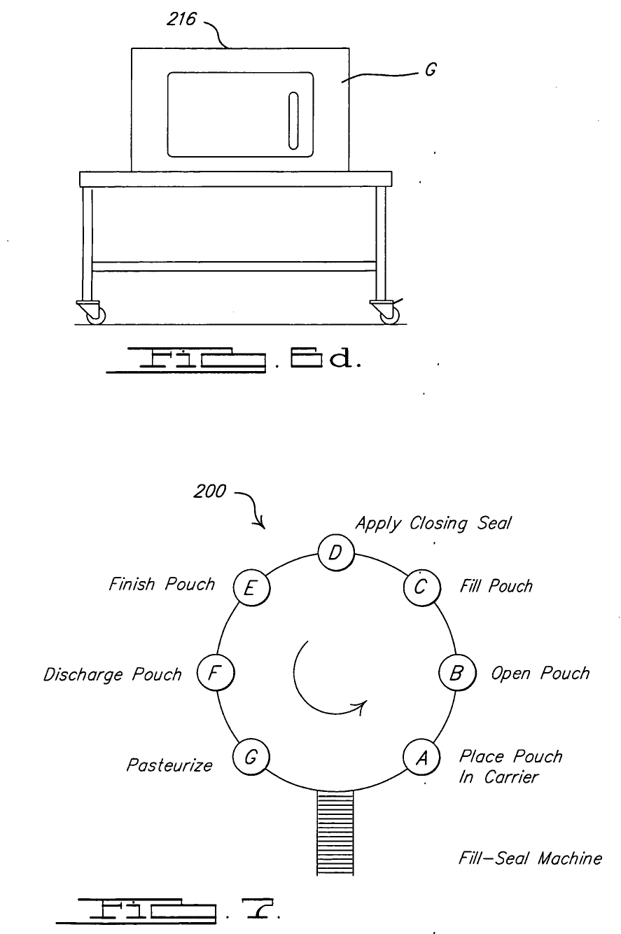

The methodology advances to block 125 and the premade pouch 10 is then removed from the machine, and is ready for filling. The formed pouches are loaded into a carrier, and the carrier is transferred to a fill-seal machine. It should be appreciated that the fill-seal machine may be integral with the pouch forming machine, or as shown in FIG. 6a, a separate machine.

Referring to FIG. 4b, a method of filling and sealing a premade pouch 10 is illustrated. It should be appreciated that if the pouch 10 will be filled “on-site”, such as at a distribution site, then the pouch 10 is delivered with all the sides sealed. The spout fitment may be sealed between the walls of the pouch, with or without the cap. The product is shelf stable for sixty days if maintained at a predetermined temperature, such in a refrigerator. However, pasteurization is used to achieve a shelf stable product at ambient temperatures.

The methodology advances to block 130 and the pouch is opened using an opening means. One example of an opening means is by injecting a gas, such as air or steam or carbon dioxide, into the pouch. Another example of an opening means are grippers. If the edges are open, the gas is injected through the open edges. If the pouch has a fitment, the gas is injected though the spout fitment. After the pouch is opened, it may be injected with a super-saturated steam to eliminate any pathogens or the like.

The methodology advances to block 135 and the product is dispensed into the pouch. The product may be maintained at a predetermined temperature, such as 32° F. to 38° F. when filled. The pouch may be filled through the open edge, or through the spout. An example of a dispenser for beer is a vacuum type dispenser, such as the TurboTap™, which minimizes foam production. This dispenser has a filling length that can be modified, depending on the application, to keep foam to a minimum. It should be appreciated that prior to filling the pouch with the product, the opened pouch may be flushed with a gas such as nitrogen or carbon dioxide, or a mixture of the both to prepare the pouch for filling.

The methodology advances to block 140 and the pouch is closed. If the edges are open, the edges are sealed. Various types of seals are contemplated. If the product is carbonated, the pouch is sealed using an ultrasonic seal through the product, as described in Patent Application No. PCT/US03/034396. It should be appreciated that any air present in the headspace of the pouch is removed prior to closing, since the presence of excess air could cause the pouch to explode. For example, the air is removed using a vacuum, or steam or a gas flush.

For example, for a carbonated product such as beer or wine, the seal is positioned in the head space of the product. A second seal is applied above the first seal. Some of the product may be captured between the first and second seal. The second seal may be an ultrasonic seal or a heat seal.

Alternatively, the pouch is filled through the spout fitment and the cap is applied. The cap may be a tamper-evident cap. The cap preferably contains an oxygen scavenger in the cap insert, and the fitment threads contain any gases in the filled pouch, to prevent leakage of the product from the pouch. Preferably the cap and fitment are of a male/female thread design to ensure a tight fit and prevent leakage.

The methodology advances to block 145 and the pouch is finished. For example, the pouch may be cooled using recirculated water.

It should be appreciated that the filled pouch may undergo other processes, such as burst testing or the like prior to packaging for shipping. These processes may take place at a station on the fill/seal apparatus, or on another apparatus.

Another example of a process is pasteurization as shown in FIG. 6d. The pasteurization may take place in a separate machine, or at an integral station on the fill machine. It should be appreciated that any air in the headspace is removed prior to placing the pouch in the chamber. The pouch is placed on its side and transferred to a pasteurization tunnel where if enters a predetermined number of water spray temperature zones, which in this example is five. In the first zone, the pouch is warmed, and as a result the laminated film begins to expand. It should be appreciated that is temperature time ratio is controlled so as not to cause damage to the metal foil, or aluminum foil layer. At a second zone, the temperature of the pouch is raised to the pasteurization temperature for a predetermined period of time. It should be appreciated that this temperature is selected based on the size and volume of the product in the pouch. At a third zone, the pouch is maintained at the predetermined pasteurization temperature for a predetermined period of time. The predetermined period of time is selected to destroy the yeast and bacterial activity. At a fourth zone, the pouch is cooled for a predetermined period of time. At a fifth zone, the pouch is cooled to a predetermined temperature. It should be appreciated that the predetermined cooling temperature is below ambient temperature. The temperatures are selected based on film construction as well as organoleptic requirements.

The methodology advances to block 150 and the sealed pouch is removed from the machine and packed. A plurality of pouches may be placed in a premade carton for sales or shipping purposes.

It should be appreciated that a particular manufacturing station may perform one or a plurality of operations, to enhance the efficiency of the methodology and apparatus. After filling, the pouch may be stored in a refrigerator for up to sixty days or if pasteurized for up to twelve weeks.

Referring to FIGS. 6 and 7, a compact fill-seal machine 200 for carrying out the method described with respect to FIG. 4b is illustrated. Various arrangements of the stations for forming the pouch are contemplated. The fill-seal machine may be configured as a flat bed, conveyor, rotary turret or the like. It should be appreciated that the fill-seal machine of FIG. 6 is a conveyor style, and FIG. 7 shows a rotary turret style. The stations are supported by a frame 202 having a generally planar top supported by a plurality of legs. It should be appreciated that the legs may include wheels, so that the machine is portable. The machine 200 is operated by an operator 204. The operator 204 may selectively move the pouches 10 between the stations. In this example, a conveyor 206 is mounted to an upper surface of the frame 202.

At a first station “A”, the individually formed pouches are unloaded from the carrier and placed into a receptacle, such as a holder 208. Various types of holders 208 are contemplated, such as grippers, or cup-shaped members. An example of a holder 208 is disclosed in commonly assigned U.S. Pat. No. 6,719,015, which is incorporated herein by reference. The holder carrying the pouch is transported along a conveying means, such as the conveyor belt 210 of this example, to station “B”.

At station “B”, the pouch 10 is opened in an opening operation using an opening means. Various techniques are conventionally known in the art for further opening the pouch 10. For example, the use of a guide pocket 24 formed by the crease in the front panel and back panel, as shown in FIG. 5, facilitates opening the upper edges of the pouch. In another example, a nozzle may be mechanically lowered into the pouch to direct a stream of compressed gas downwardly into the pouch 10 to force the walls of the pouch away from each other to further open an upper edge of the pouch. An example of a gas is carbon dioxide or nitrogen. In another example, a combination of suction cups and grippers may also be utilized to open the pouch. The grippers assist in maintaining the pouch in an open position. In still another example, the opening station includes a blowing station with a manifold, and a hood extending over the top of the edges of the pouch. The manifold has rows of apertures formed above the upper edges of the panels of the pouch 10. The hood is placed over the pouch to assist in maintaining the air pressure in the pouch. The supply of pressurized gas is directed through the aperture to form a plurality of jets of pressurized gas or air. The jets are directed downwardly at the diamond-shaped openings formed at the upper edges to assist in overcoming the surface tension of the panels and assist in separation of the panels. A diving rod may then be used to make sure the pouch is fully opened. An example of such an opening operation is disclosed in commonly assigned U.S. patent application Ser. No. 10/310,221, which is incorporated herein by reference. In addition, after the pouch is opened, a super saturated steam may be injected in the pouch to eliminate any pathogens.

The opened pouch 10 is transferred to a filling station as indicated at “C”, and the pouch 10 is filled with the product using a filling means 212. For example, a fill nozzle dispenses a predetermined amount of product into the opened pouch. In this example, the fill nozzle 212 is lowered into the opened pouch 10, and the product is dispensed into the open pouch, as previously described. It should be appreciated that the product may be dispensed through the opened edges of the pouch or through a fitment. If the pouch is filled through the fitment, it is filled to the top edge of the fitment.

If the product is naturally carbonated, such as beer, wine or soda or the like, the pouch is preferably filled while immersed in a nitrogen or carbon dioxide atmosphere. The pouch may be flushed with nitrogen or carbon dioxide or a mixture of both. If the product is not naturally carbonated, it is immersed in a carbon dioxide process to introduce carbon dioxide into the product, such as a carbonator or the like. For example, carbon dioxide is introduced into water or juice to provide a carbonated beverage. The product may contain a mixture of up to six volumes of carbon dioxide. It should be appreciated that the carbon dioxide masks any undesirable taste from the ketones released during the pouch sealing process. The carbon dioxide also increases the pressure within the pouch, so that the walls of the pouch are rigid after the top is sealed. The product is preferably filled at a temperature ranging from 32°-38° F. The carbonation is advantageous as a microbiocide which can enhance the flavor or prevent mold or contamination.

The pouch is transferred to a closing station and the open edges of the pouch are closed, as indicated at “D”. If the edges of the pouch are open, the edges are sealed using a sealing means 214. Various types of seals are contemplated, depending on the product and intended use of the pouch. One example of a seal is a heat weld. In this example, a heat-sealing member seals the upper edge of pouch. It should be noted that the filled pouch might return to a partially closed position due to the product contained therein prior to sealing.

Another example of a sealing technique for a carbonated product utilizes an ultrasonic sealing process, as previously described. An example of a sealing technique for a carbonated product is disclosed in commonly assigned Patent Application No. PCT/US03/34396, which is incorporated herein by reference. The headspace of the pouch may be flushed with a gas prior to closing. In this example, a first temporary ultrasonic seal is applied to the open edges of the pouch. Preferably the ultrasonic seal includes sound waves and is formed using a horn and anvil. A second seal is applied using a heat seal means to form a second, permanent seal over the first seal. It should be appreciated that the second seal may be spaced slightly above the first seal, and some of the product may be trapped between the first and second seals. The second heat seal is conventional and utilizes heat or a combination of heat and pressure to form the second seal positioned above the first seal. It should be appreciated that the permanent seal may also be a cosmetic seal.

If the pouch is filled through the fitment, the pouch is closed by securing a cap to the fitment. The cap may have a tamper-evident feature. The cap and fitment preferably have leak-proof features as previously described for a carbonated product.

The pouch may be transferred to a finishing station (not shown), and finished. For example, the filled pouch 10 may be washed.

If the pouch is finished, the completed pouch is discharged from the machine at a discharge station as shown at “F”. In this example, the finished pouches are discharged into a premade carrier, such as a carton or package or the like. For example, the user places the pouch in a box for distribution purposes. The sealed pouch may be transferred to a refrigerated storeroom. The refrigerated storeroom may be maintained at a predetermined temperature, such as 32 to 38° F. Storage, such as refrigeration, enhances the shelf life of the product. For example, a refrigerated product may have a shelf life of up to sixty days. In comparison, a pasteurized product may have a shelf life of up to twelve weeks.

The pouch may be finished at a pasteurization station 216, as shown at “G”. This station may be an integral station with the machine, or a separate station. One example of such a station is known as a retort chamber. An advantage of pasteurization of the filled flexible pouch is that the pouch has a shelf stable life of 10-12 weeks at ambient temperature. This is important for a product such as beer or wine, where the product is judged by flavor and quality.

The product inside the pouch is pasteurized using variable water temperatures for variable time periods. In this example, five water spray temperature zones are utilized, as previously described. These zones include a first warming zone, a second temperature heating zone, a third pasteurization temperature holding zone, a fourth cooling zone, and a fifth below ambient temperature cooling zone. A combination of steam and water may be used to heat the pouch 10 to the previously described predetermined temperatures for the predetermined periods of time, to pasteurize the product contained within the pouch 10. The pouch 10 is then cooled. It should be appreciated that, recirculated water may be utilized to cool the pouch. In certain instances, it may be desirable to apply steam to sterilize the pouch 10 and to wet the inner surface of the walls to facilitate removal of bacteria or other such pathogens.

It should be appreciated that the machine 200 may include other stations, such as an upstream oxygen purging station, downstream oxygen purging station, or the like. In addition, a manufacturing station may perform one or a plurality of operations, to enhance the efficiency of the methodology.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the present invention may be practiced other than as specifically described.

1. A flexible pouch for storing and serving a carbonated product that has an ergonomic shape for holding the pouch while consuming the carbonated product, said pouch comprising:
a panel having an inner surface and an outer surface, and an upper edge, an opposed lower edge and a first side edge and a second side edge extending therebetween the upper edge and the lower edge, wherein the panel is folded lengthwise so that the side edges form one sealed side seam and the folded edge forms a soft side edge that is ergonomically shaped for holding the pouch while consuming the carbonated product, the upper edges are sealed along an upper seam and the lower edges are sealed along a lower seam that includes a first ultrasonic seal and a second seal spaced a predetermined distance from the first seal so that some of the product is trapped between the first and second seal; and
an opening means disposed in the upper seam for accessing the carbonated product contained within the pouch.

2. The pouch as set forth in claim 1 wherein said opening means is a fitment having a spout and a cap removably connected to the spout.

3. The pouch as set forth in claim 1 wherein said pouch includes an insert positioned between the lower edges so that the pouch can stand upright.

4. The pouch as set forth in claim 1 wherein said panel is made from a laminate material having at least one extrusion layer.

5. A method of filling a flexible pouch with a carbonated product using a compact machine for extended shelf life of the filled pouch, said method comprising the steps of:
placing a premade flexible pouch in holder for transporting the pouch between stations on a compact machine, wherein the premade flexible pouch includes a panel having an inner surface and an outer surface, and an upper edge, an opposed lower edge and a first side edge and a second side edge extending therebetween the upper edge and the lower edge, the upper edges are sealed along an upper seam and an opening means is disposed in the upper seam for accessing the carbonated product contained within the pouch and the lower edges are open;
opening the pouch at an opening station on the compact machine by directing a flow of gas between the open lower edges of the pouch to separate the walls of the pouch;
filling the pouch at a filling station on the compact machine with the carbonated product through the opened edges using a filling nozzle;
sealing the open edges of the pouch at a sealing station by applying a first ultrasonic seal and a second seal spaced a predetermined distance from the first seal so that some of the product is trapped between the first and second; and
removing the filled pouch from the compact machine.

6. The method as set forth in claim 5 further including the step of pasteurizing the pouch to extend the shelf life of the filled and sealed pouch at ambient temperature by:
warming the pouch at a predetermined warming temperature for a predetermined warming period of time;
raising a temperature of the pouch to a predetermined pasteurization temperature in a predetermined temperature raising period of time;
holding the temperature of the pouch at the predetermined pasteurization temperature for a predetermined holding period of time;
cooling the temperature of the pouch for a predetermined cooling period of time; and
cooling the temperature of the pouch to a predetermined sub-ambient temperature, so that the pouch is shelf stable at ambient temperature.

7. A method of filling a flexible pouch with a product using a compact machine for extended shelf life of the filled pouch, said method comprising the steps of:
placing a premade flexible pouch in holder for transporting the pouch between stations on a compact machine, wherein the flexible pouch includes a panel having an inner surface and an outer surface, and an upper edge, an opposed lower edge and a first side edge and a second side edge extending therebetween the upper edge and the lower edge, the upper edges are sealed along an upper seam and a fitment opening means is disposed in the upper seam for accessing the product contained within the pouch and the lower edges are sealed;
opening the pouch at an opening station on the compact machine by directing a flow of gas through the fitment to separate the walls of the pouch;
dispensing the product into the opened pouch through the fitment at a filling station on the compact machine using a filling nozzle;
placing a cap on the fitment to seal the pouch at a capping station; and
removing the filled pouch from the compact machine.

8. The method as set forth in claim 7 further including the step of pasteurizing the product within the sealed pouch to extend the shelf life of the filled and sealed pouch at ambient temperature by:
warming the pouch at a predetermined warming temperature for a predetermined warming period of time;
raising a temperature of the pouch to a predetermined pasteurization temperature in a predetermined temperature raising period of time;
holding the temperature of the pouch at the predetermined pasteurization temperature for a predetermined holding period of time;
cooling the temperature of the pouch for a predetermined cooling period of time; and
cooling the temperature of the pouch to a predetermined sub-ambient temperature, so that the pouch is shelf stable at ambient temperature.

9. A compact apparatus for filling a flexible pouch with a carbonated product comprising:
a frame having a planar top and legs supporting the top;
a transport means disposed on the frame top for transporting a pouch holder that supports the flexible pouch;
a receiving station for placing an unfilled flexible pouch into the pouch holder, wherein the unfilled flexible pouch includes a panel having an inner surface and an outer surface, and an upper edge, an opposed lower edge and a first side edge and a second side edge extending therebetween the upper edge and the lower edge, the upper edges are sealed along an upper seam and a fitment opening means is disposed in the upper seam for accessing the carbonated product contained within the pouch and the lower edges are open;
an opening station mounted to the frame for opening the pouch by directing a flow of gas between the open lower edges of the pouch to separate the walls of the pouch;
a filling station mounted to the frame for filling the pouch with a carbonated product using a filling nozzle; and
a sealing station mounted to the frame for sealing the open edges of the pouch by applying a first ultrasonic seal and a second seal spaced a predetermined distance from the first seal so that some of the product is trapped between the first seal and second seal.

10. The compact apparatus as set forth in claim 9 further including a station for pasteurizing the product within the sealed pouch, wherein the pasteurization station includes a first warming zone that warms the pouch at a predetermined warming temperature for a predetermined warming period of time, a second temperature raising zone that raises the temperature of the pouch to a predetermined pasteurization temperature in a predetermined temperature raising period of time, a third holding zone for holding the temperature of the pouch at the predetermined pasteurization temperature for a predetermined holding period of time, a fourth cooling zone for cooling the temperature of the pouch for a predetermined cooling period of time and a fifth cooling zone for cooling the temperature of the pouch to a predetermined sub-ambient temperature, so that the pouch is shelf stable at ambient temperature.

11. A compact apparatus for filling a flexible pouch with a product comprising:
a frame having a planar top and legs supporting the top;
a transport means disposed on the frame top for transporting a pouch holder that supports the flexible pouch;
a receiving station for placing an unfilled flexible pouch into the pouch holder, wherein the unfilled flexible pouch includes a panel having an inner surface and an outer surface, and an upper edge, an opposed lower edge and a first side edge and a second side edge extending therebetween the upper edge and the lower edge, the upper edges are sealed along an upper seam and a fitment opening means is disposed in the upper seam for accessing the carbonated product contained within the pouch and the lower edges are sealed;
an opening station mounted to the frame for opening the pouch by directing a flow of gas through the fitment to separate the walls of the pouch;
a filling station mounted to the frame for filling the pouch with a carbonated product through a spout fitment to the upper edge of the spout fitment using a filling means; and
a closing station for closing the spout by placing a cap on the spout.

12. The method as set forth in claim 11 further including a station for pasteurizing the product within the sealed pouch within the sealed pouch, wherein the pasteurization station includes a first warming zone that warms the pouch at a predetermined warming temperature for a predetermined warming period of time, a second temperature raising zone that raises the temperature of the pouch to a predetermined pasteurization temperature in a predetermined temperature raising period of time, a third holding zone for holding the temperature of the pouch at the predetermined pasteurization temperature for a predetermined holding period of time, a fourth cooling zone for cooling the temperature of the pouch for a predetermined cooling period of time and a fifth cooling zone for cooling the temperature of the pouch to a predetermined sub-ambient temperature, so that the pouch is shelf stable at ambient temperature.
